(19) United States
(12) Patent Application Publication
(10) Pub. No.: US 2015/0076829 A1
(43) Pub. Date: Mar. 19, 2015

(54) APPARATUS FOR HARVESTING WIND

(71) Applicant: John A. Saavedra, Irmo, SC (US)

(72) Inventor: John A. Saavedra, Irmo, SC (US)

(21) Appl. No.: 14/515,119

(22) Filed: Oct. 15, 2014

Related U.S. Application Data
(63) Continuation-in-part of application No. 14/468,489, filed on Aug. 26, 2014.
Application No. 14/468,489 is a continuation-in-part of application No. 14/031,201, filed on Sep. 19, 2013, now Pat. No. 8,896,145.

(51) Int. Cl. F03D 5/06; F03D 9/00

(52) U.S. Cl. CPC F03D 5/06; F03D 9/007; F03D 9/002
USPC 290/55

(57) ABSTRACT

The invention is a power generator using fluid flow. The apparatus includes a columnar article extending perpendicularly from a base, one or more fixture points adjacent the base, one or more attachment cords extending from the fixture points to columnar article, and one or more power generators carried by the fixture points and attached to the cords. In the absence of fluid flow, the columnar article resides in a rest position, perpendicular to the base. In the presence of fluid flow, the columnar article flexes to a flexed position away from the rest position. When the columnar article flexes from the rest position to the flexed position in response to fluid flow, power is generated by the movement of the attachment cord for use by a power consuming, a power storing, or a power transmitting device.

### CROSS REFERENCE TO RELATED PATENT APPLICATIONS

This application is a continuation-in-part of, expressly incorporates by reference, and claims the benefit of and priority to co-pending U.S. application Ser. No. 14/468,489, filed on Aug. 26, 2014, which is a continuation-in-part of U.S. application Ser. No. 14/031,201, filed on Sep. 19, 2013, which itself is a continuation-in-part of U.S. application Ser. No. 13/678,770, filed on Nov. 16, 2012, now U.S. Pat. No. 8,742,614.

This application is also a continuation-in-part of, expressly incorporates by reference, and claims the benefit of and priority to co-pending U.S. application Ser. No. 14/031,201, filed on Sep. 19, 2013 which is a continuation-in-part of U.S. application Ser. No. 13/678,770, filed on Nov. 16, 2012, now U.S. Pat. No. 8,742,614.

This application, likewise, expressly incorporates by reference, and claims the benefit of and priority to U.S. application Ser. No. 13/678,770, filed on Nov. 16, 2012, now U.S. Pat. No. 8,742,614.

### TECHNICAL FIELD AND BACKGROUND OF THE INVENTION

The invention relates generally to the field of power generation. More particularly, the invention relates to the field of generating power from fluid flows which may be constant, nearly constant, intermittent, variable, gusty wind or other fluids around a rod.

For centuries, wind has been used to power windmills and wind turbines. Typical wind-energy systems are placed in locations known to have consistent natural winds. A typical windmill has a blade assembly that executes full rotations on an axis that is horizontal. Such systems are suited for harnessing the energy of consistently directional winds. They are not well suited for harnessing the energy of intermittent, spurious, or gusty winds. Winds at ground level are considered too intermittent for use in conventional turbines. Terrain, buildings, houses, traffic, and other variables tend to disturb prevailing winds, and are considered detrimental to capturing the energy in wind flows, generally more stable above the immediate surface of the Earth.

A typical windmill requires long and complex blades constructed of expensive materials which are developed to turn rapidly in hill top and sea side locations where strong winds are present. Tall and expensive towers are needed to elevate the blades to safely permit full rotation and to reach wind patterns far above the ground.

Typical windmills often kill bats and birds, especially migratory birds, and they generate unwelcome noise. They disrupt skylines and viewing vistas for which people have paid good money. Further, typical wind turbines are limited in high winds because they have to be shut down in high winds to prevent their own damage.

Thus, typical systems for collecting energy from wind are not suited for use by individuals and small businesses and others who could collect wind energy at ground level. Likewise, they are not suited for use by the one in five people on Earth who currently live away from and are not connect to any electrical grid. A typical wind-energy system has a large structure that is difficult to disassemble and move, and is therefore not suited for transportation and relocation. However, electric utility companies give credit for any electricity a customer produces through a process known as net metering, and so an incentive is in place for even individuals to enter the power producing arena.

Importantly, typical available wind-energy systems are not suited for harnessing the energy of ground level winds despite that great energy resources are available at low altitudes. For example, the air movements created by passing vehicles along roadways represent an unused energy resource. Another example is air movements created by aircraft that land and take off from airports. Further, such examples include intermittent wind at the rooftop level of buildings and other structures such as sports arenas or even petroleum and diesel refilling stations.

Therefore, there is a need for an improved power generator utilizing intermittent winds as well as sustained winds.

### SUMMARY OF THE INVENTION

It is therefore an object of the present invention to provide a power generator that uses intermittent fluid flow such as intermittent wind, intermittent water waves, and intermittent water current flow. The invention utilizes a columnar article mounted on a base allowing the columnar article to flex in response to fluid flows. The basis for some of the embodiments of the invention relies on an intermittent, gusty, variable fluid flow that is generally horizontal level ground. However, the invention contemplates that the apparatus may be deployed in a variety of environments including those where the wind is not parallel level ground. When no fluid is flowing, the columnar article rests in position that is generally perpendicular to the base.

As fluid flow increases, the columnar article flexes and one or more cords attached to the columnar article extend or retract, depending on the direction of flexure, thereby transferring the energy from the movement of the columnar article to a power generator. With these concepts in mind, the following is a summary and description of the invention which may use the term “wind” to refer to such fluid flows. However, this reference is not intended to unduly limit the invention to movements of air comprising wind as the invention encompasses other similar fluid flows.

These and other aspects of one embodiment of the invention are achieved by providing a power generating apparatus adapted for utilizing intermittent fluid flow including a columnar article extending perpendicularly from a base. In the absence of fluid flow, the columnar article is biased in a rest position about a perpendicular axis relative to the base. The columnar article flexes from the rest position to a flexed position in the presence of fluid flow. In the flexed portion, an end of the columnar article opposite the base is displaced a distance from the perpendicular axis. The apparatus may include one or more fixture points adjacent the base. The apparatus may include one or more attachment cords extending from the fixture points to columnar article. The apparatus may further include one or more power generators carried by the fixture points, operably attached to the attachment cords, and adapted to actuate when the columnar article moves from the rest position to the flexed position in response to fluid flow. According to such an arrangement, power is generated by the movement of the attachment cord for use by a power consuming, a power storing, or a power transmitting device.

According to an embodiment of the invention, the power consuming, power storing, or power transmitting device includes a gear set. The gear set may include a transmission or gearing which converts high-torque, low RPM's produced by the wind to the much higher RPM's needed by permanent magnet alternators or other power generating device.

According to another aspect of one embodiment of the invention, the columnar article is biased in the rest position by a spring.

According to another aspect of one embodiment of the invention the flexing of the columnar article occurs gradually along an entire length of the columnar article.

According to another aspect of one embodiment of the invention the flexing of the columnar article occurs gradually along an upper portion of the columnar article.

According to another aspect of one embodiment of the invention the flexing of the columnar article occurs at a pivot point. The pivot point may be located along the length of the columnar article. Alternatively, the pivot point may be located at a point where the base is connected to the columnar article.

According to another aspect of one embodiment of the invention, the attachment cords are defined by a total length comprising the entire length of the cord; an exposed length comprising the length of the cord between the fixture point and the columnar article, and an excess length comprising the total length less the exposed length. According to such an embodiment, the fixture point includes a spring biasing the excess length in the cord rest position such that, as the columnar article flexes from the rest position to the flexed position in a direction away from the fixture point, the excess length decreases and, as the columnar article flexes from the rest position to the flexed position in a direction toward the fixture point, the excess length increases.

According to another aspect of one embodiment of the invention, the excess length is wound around a spool which spins as the excess length increases or decreases.

According to another aspect of one embodiment of the invention the power generator is a permanent-magnet alternator that generates electrical power as the excess length of the attachment cord increases or decreases due to the spinning of the spool.

According to another aspect of one embodiment of the invention, the power generator comprises a hydraulic cylinder or a plurality of hydraulic cylinders attached to the attachment cords, the hydraulic cylinders storing a quantity of hydraulic fluid under pressure in an accumulator reservoir as the attachment cords are pulled by the flexing of the columnar article.

According to another aspect of one embodiment of the invention, the hydraulic cylinder or hydraulic cylinders are attached to a hydraulic electrical generator and wherein the quantity of hydraulic fluid is released to power the hydraulic electrical generator when an optimum pressure level is achieved. Such an embodiment may include a return reservoir for the hydraulic fluid that has been used by the generators. This return reservoir could function to store and/or recycle the hydraulic fluid that would be reused by the hydraulic cylinders.

According to another aspect of one embodiment of the invention, the base further comprises a turntable and a wind vane is operably attached to the base. The turntable and the wind vane operate to ensure that the columnar article faces the optimum direction for harvesting fluid flows.

According to another aspect of one embodiment of the invention, signage is attached to the columnar article.

According to another aspect of one embodiment of the invention the columnar article further includes a plurality of photovoltaic cells.

According to another aspect of one embodiment of the invention the base is attached to a movable vehicle.

According to another aspect of one embodiment of the invention the base is attached to a building.

According to another aspect of one embodiment of the invention, the columnar article is a tree.

According to another aspect of one embodiment of the invention, the columnar article is an antenna tower.

According to another aspect of one embodiment of the invention, the columnar article is a flag pole.

According to another aspect of one embodiment of the invention, the signage comprises displays selected from the group consisting of flags, banners, and pennants. This signage may serve the purpose of a wind resister to aid in the flexing of the columnar article. Or, the signage consisting of flags, banners, and pennants, may simply serve the function of advertising and graphic display.

According to another aspect of one embodiment of the invention, the signage comprises recycled refuse selected from the group consisting of soda bottles, milk jugs, and clothing. This signage, in contrast to the flags discussed supra, functions as a wind resister to aid the columnar article in flexing. Such signage may also form the function of recycling and repurposing the bottles, jugs, clothing, etc.

### BRIEF DESCRIPTION OF THE DRAWINGS FIGURES

Features, aspects, and advantages of a preferred embodiment of the invention are better understood when the detailed description is read with reference to the accompanying drawings, in which:

FIG. 1 is a side view of an embodiment of the apparatus showing flexure of the columnar article in response to wind;

FIG. 2 is a side view of an embodiment of the apparatus utilizing a tree as the columnar article and showing flexure in response to wind;

FIG. 3 is a top view of an embodiment of the apparatus utilizing three fixture points and three attachment cords;

FIG. 4 is a top view of an embodiment of the apparatus utilizing four fixture points and four attachment cords;

FIG. 5 is a top view of an alternate embodiment of the apparatus of FIG. 4 showing an alternate attachment of the cords; to the columnar article;

FIG. 6 is a perspective view of an arrangement of a plurality of columnar articles, attachment cords, and fixture points;

FIG. 7 is a perspective view of an embodiment of the invention utilizing an antenna tower as a columnar article, four fixture points, and eight attachment cords;

FIG. 8 is a perspective view of an embodiment of the invention utilizing an antenna tower as a columnar article, four fixture points, and eight attachment cords;

FIG. 9 is a perspective view of an embodiment of the invention utilizing a flag pole as the columnar article;

FIG. 10 is a perspective view of an embodiment of the invention utilizing multiple columnar articles located atop a building; and

FIG. 11 is a perspective view of an embodiment of the invention utilizing a flag pole as the columnar article and utilizing a single attachment cord and a single fixture point.

### DETAILED DESCRIPTION

The present discussion is a description of exemplary embodiments only and is not intended as limiting the broader aspects of the present invention. The following example is provided to further illustrate the invention and is not to be construed to unduly limit the scope of the invention.

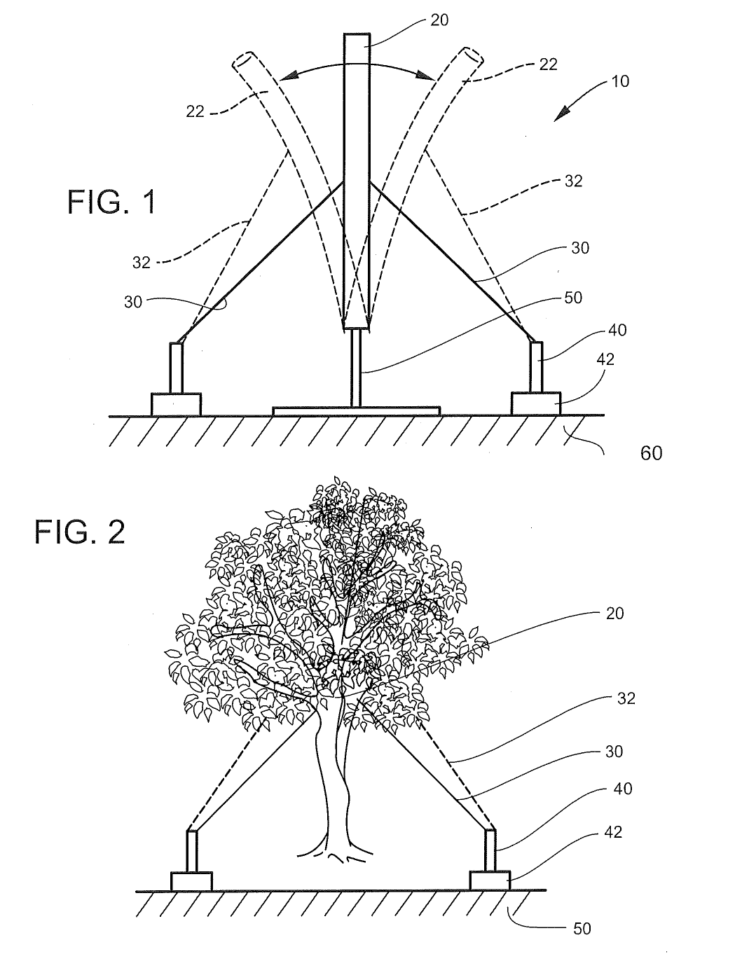

Referring to the drawings wherein identical reference numerals denote the same elements throughout the various views, FIGS. 1 and 2 illustrate the apparatus for harvesting wind 10 utilizing a columnar article 20 that is flexible. The columnar article 20 flexes from a rest position to a flexed position 22 (shown in dotted lines). As shown in FIG. 1, the columnar article 20 may be a flexible column or, by way of non-limiting example, as shown in FIG. 2, the columnar article 20 may be a tree 20. The columnar article 20 of FIG. 1 may be a simple foam “pool noodle” that flexes in the wind. The columnar article is fixed to a base 50 which may be attached or resting, as shown, on horizontal ground 60. Attachment cords 30 are attached to the columnar article 20 and to fixture points 40. The fixture points may have power generators 42 attached thereto. As the columnar article 20 flexes from the rest position to the flexed position 22, the cord 30 retracts 32 into the fixture point 42. The retraction movement powers the power generator 42. As the columnar article 20 returns from the flexed position 22 to the rest position, the cord 30 likewise extends back, also actuating the power generator. The fixture points 40 may include an internal spool that is biased in the rest position by a spring. The biasing spring (not shown) encourages the cord 30 to extend or retract with the flexing of the columnar article 20. The movement of the spool during extension or retraction may turn a permanent magnet generator. Alternatively, the spring may be the spring force of the pool noodle as in FIG. 1 which returns the columnar article 20 to the rest position, or the spring may be the spring force of the tree which returns the columnar article 20 to the rest position. That is, the noodle and the tree, as columnar articles 20, are natively biased in an erect, rest position and their spring force returns them to this position in the absence of wind.

The power generators 42 may include a gear set (not shown). The gear set may include transmission gears which convert high-torque, low RPM's produced by the wind to the much higher RPM's needed by permanent magnet alternators or other power generating device.

The effectiveness of the device 10 may be increased and enhanced by attaching lightweight, rigid objects to the columnar articles 20 to increase resistance to the wind, thus increasing the range of flex and force of movements of the columns 20. For example, lightweight, rigid structures made of materials like Styrofoam, Corex plastic boards, foamboard, or light wood may attached to the tops of the columnar articles 20, such surfaces and structures to be used as mounting surfaces for signs and advertising. By way of example, foam cylinders, commonly called “pool noodles,” as shown via the columnar article 20 in FIG. 1, would also serve to increase the area of resistance to the wind, resulting in increased movement of the columnar article 20 in response to winds. With developing countries in mind, these additions, which provide greatly increased wind resistance with little increase in overall mass, could be made of common, indigenous or recycled materials, such as, but not limited to, empty plastic milk bottles, soda bottles, palm fronds, bamboo, excess lightweight (aluminum) scrap metal, thatch, etc . . . .

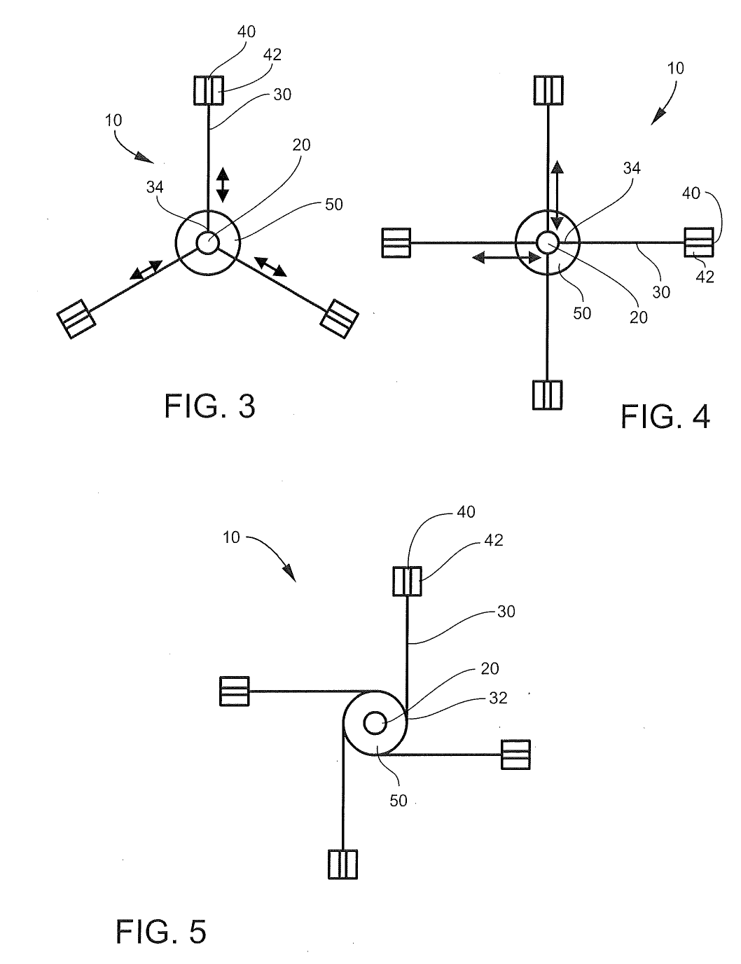

As shown in FIGS. 3, 4, and 5, the apparatus 10 contemplates many different arrangements of cords 30 and fixture points 40. As shown in FIG. 3, the apparatus 10 may include three cords 30 and three fixture points 40 connected to three power generators 42. As shown in FIG. 4, the apparatus 10 may include four cords 30 and three fixture points 40 connected to three power generators 42. As shown in FIG. 5, the attachment of the cords 30 to the columnar article 20 may be tangential rather than perpendicular as in FIGS. 3 and 4.

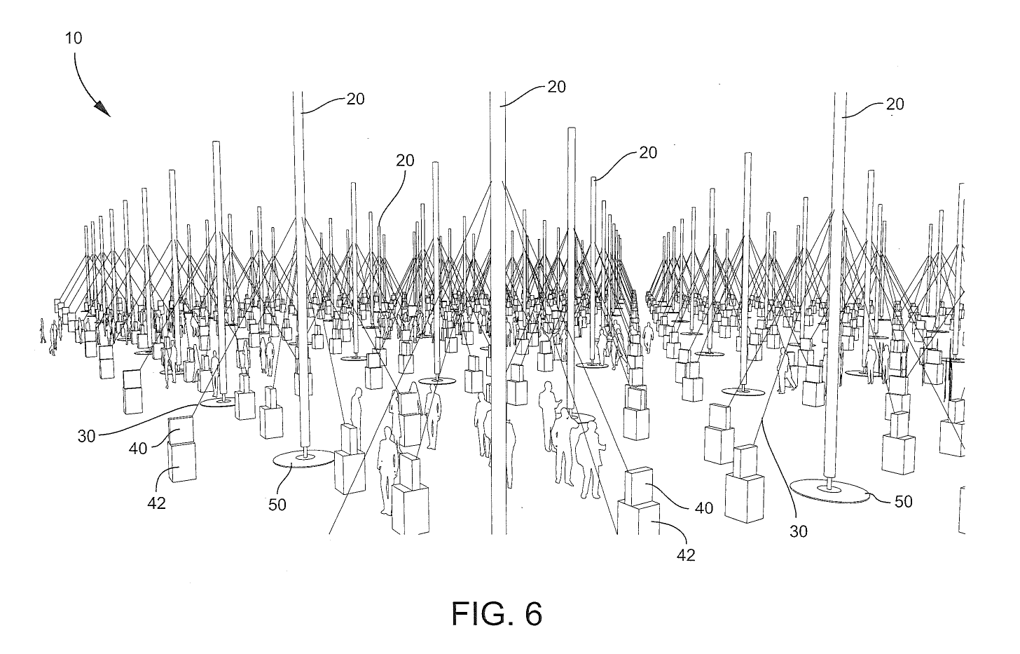

As shown in FIG. 6, the invention 10 expressly contemplates that the multiple columnar articles 20 being deployed in an environmental setting to capture wind or other fluid flows. Though FIG. 6 shows the cords 30 spaced far apart forms the columnar article 20, the invention 10 also contemplates the cords 30 spaced very near (not shown) the base 50.

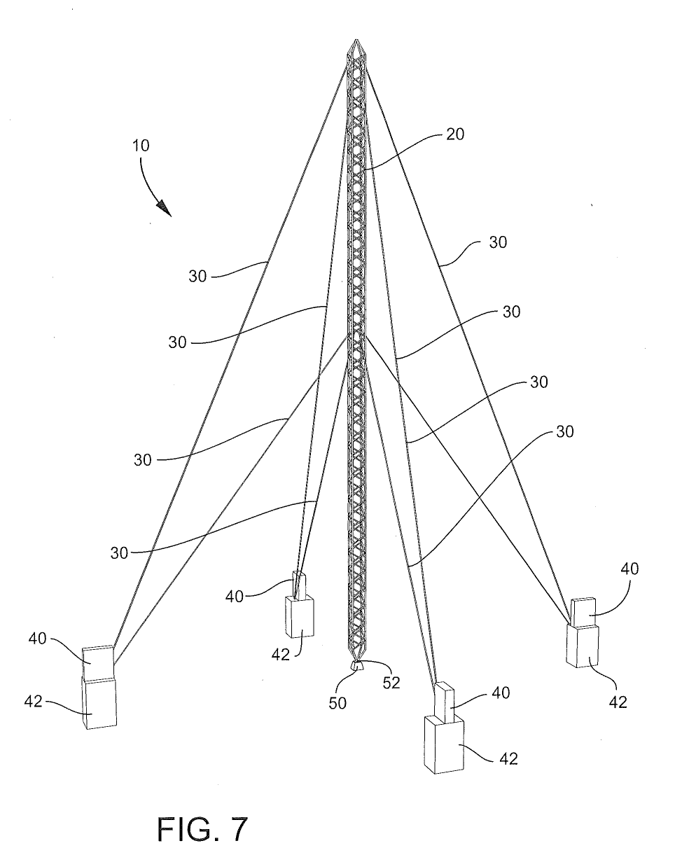

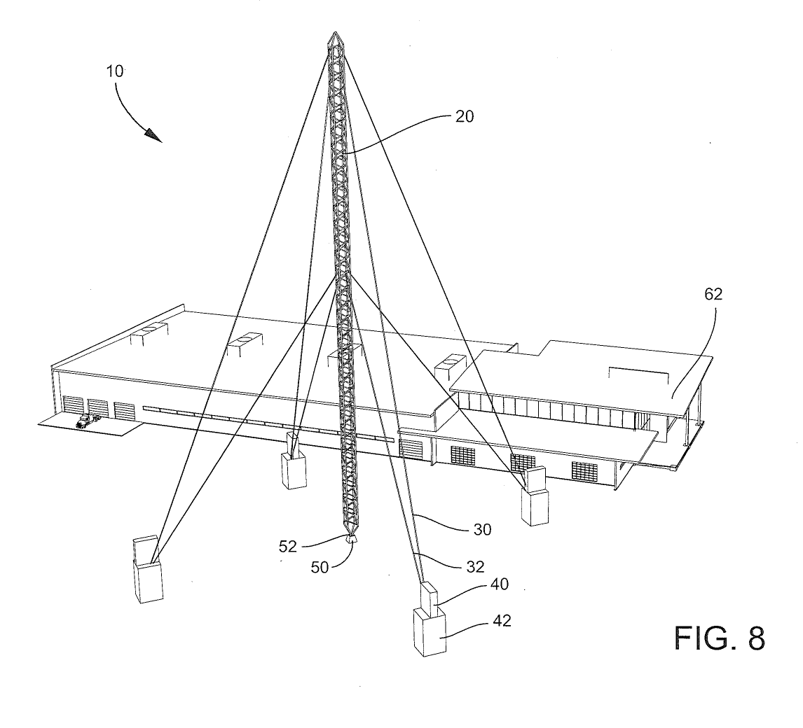

FIG. 7 and FIG. 8 illustrates the invention 10 deployed wherein the column article 20 is an antenna tower. The columnar article 20 is attached to the base 50 at a pivot point 52. The cords 30 are substantially in tension to keep the tower erect but nonetheless extend and retract enough to generate power via the power generators 42. FIG. 7 and FIG. 8 also illustrate that multiple cords 30 may be attached to a single fixture point 40. FIG. 8 illustrates that the invention 10 may be deployed near a building 62.

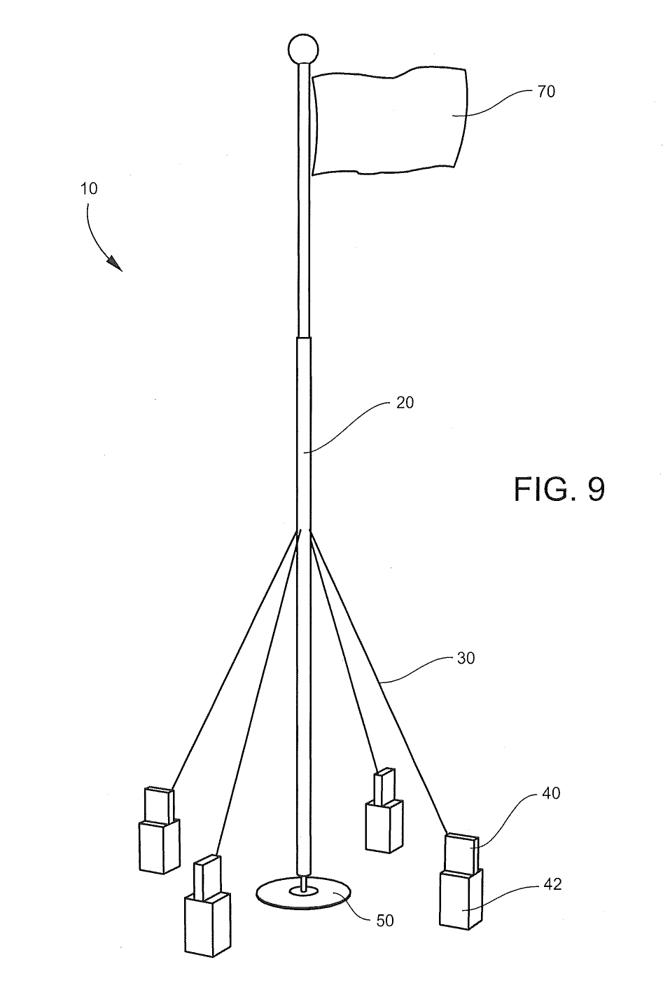

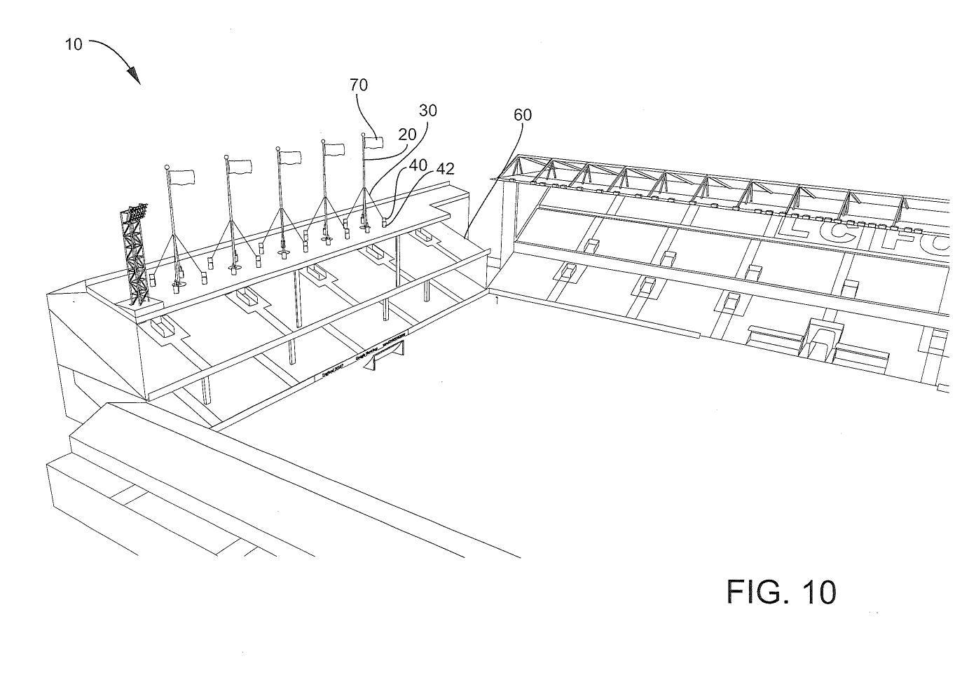

As shown in FIG. 9 and FIG. 10, the apparatus 10 contemplates that the columnar article 20 may be a flag pole having a flag 70. The flag, 70, may be an actual flag or it may be a banner, pennant, or refuse container such as a soda bottle, milk jug or similar device (not shown) which like a flag may aid the columnar article 20 in harnessing the wind. Advertising signage (not shown) may be displayed on the flag 70. As shown in FIG. 10, the columnar article may be affixed atop a building 60 such as a stadium.

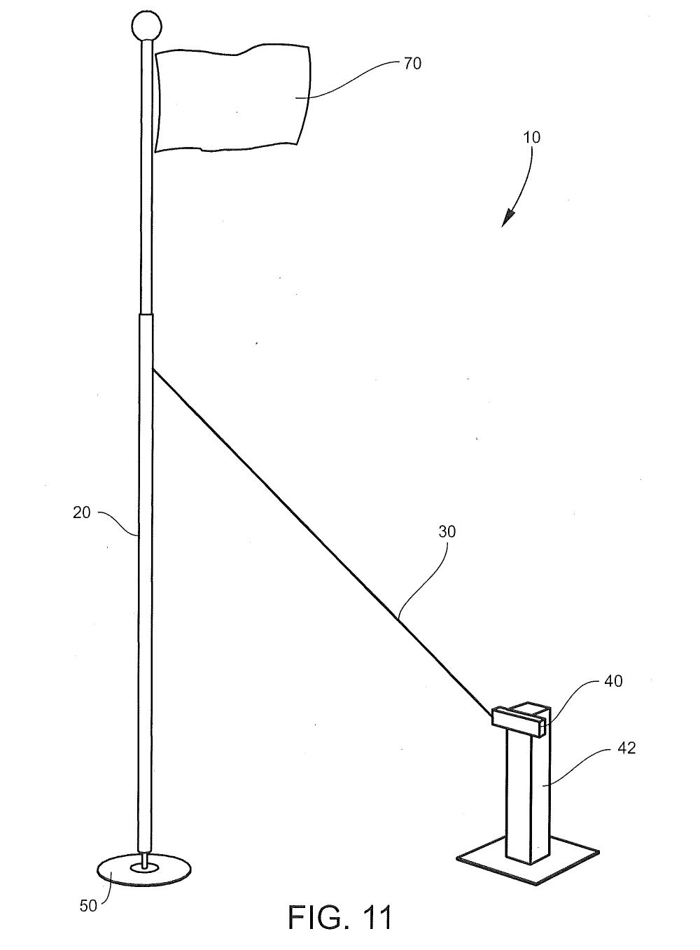

As shown in FIG. 11, the invention will function with even a single cord 30, a single columnar article 20, a single fixture point 40, and a single generator 42.

The foregoing describes an apparatus 10 for power generation utilizing fluid flows. While specific embodiments of the present invention have been described, it will be obvious to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A power generating apparatus adapted for utilizing fluid flow comprising:
a. a columnar article extending perpendicularly from a base and, in the absence of fluid flow, biased in a rest position about a perpendicular axis relative the base, the columnar article flexing from the rest position to a flexed position in the presence of fluid flow such that in the flexed portion an end of the columnar article opposite the base is displaced a distance from the perpendicular axis;
b. one or more fixture points adjacent the base;
c. one or more attachment cords extending from the fixture points to columnar article; and
d. one or more power generators carried by the fixture points, operably attached to the attachment cords, and adapted to actuate when the columnar article moves from the rest position to the flexed position in response to fluid flow such that power is generated by the movement of the attachment cord for use by a power consuming, a power storing, or a power transmitting device.

2. The power generating apparatus of claim 1 wherein the columnar article is biased in the rest position by a spring and the power consuming, the power storing, or the power transmitting device further includes a gear set.

3. The power generating apparatus of claim 1 wherein the flexing of the columnar article occurs gradually along an entire length of the columnar article.

4. The power generating apparatus of claim 1 wherein the flexing of the columnar article occurs gradually along an upper portion of the columnar article.

5. The power generating apparatus of claim 1 wherein the flexing of the columnar article occurs at a pivot point.

6. The power generating apparatus of claim 5 wherein the pivot point is located along the length of the columnar article.

7. The power generating apparatus of claim 5 wherein the pivot point is located at a point where the base is connected to the columnar article.

8. The power generating apparatus of claim 1 wherein the attachment cords are defined by:
a. a total length comprising the entire length of the cord;
b. an exposed length comprising the length of the cord between the fixture point and the columnar article; and
c. an excess length comprising the total length less the exposed length;
d. wherein the fixture point includes a spring biasing the excess length in the cord rest position such that, as the columnar article flexes from the rest position to the flexed position in a direction away from the fixture point, the excess length decreases and, as the columnar article flexes from the rest position to the flexed position in a direction toward the fixture point, the excess length increases.

9. The power generating apparatus of claim 8 wherein the excess length is wound around a spool which spins as the excess length increases or decreases.

10. The power generating apparatus of claim 9 wherein the power generator is a permanent-magnet alternator that generates electrical power as the excess length of the attachment cord increases or decreases due to the spinning of the spool.

11. The power generating apparatus of 1 wherein the power generator comprises a hydraulic cylinder or a plurality of hydraulic cylinders attached to the attachment cords, the hydraulic cylinders storing a quantity of hydraulic fluid under pressure in an accumulator reservoir as the attachment cords are pulled by the flexing of the columnar article.

12. The power generating apparatus of claim 11 wherein the hydraulic cylinder or hydraulic cylinders are attached to a hydraulic electrical generator and to a hydraulic reservoir and wherein the quantity of hydraulic fluid is released to power the hydraulic electrical generator when an optimum pressure level is achieved.

13. The power generating apparatus of claim 1 wherein the base further comprises a turntable and a wind vane operably attached to the base, the turntable and the wind vane operating to ensure that the columnar article faces the optimum direction for harvesting fluid flows.

14. The power generating apparatus of claim 1 wherein signage is attached to the columnar article.

15. The power generating apparatus of claim 1 wherein the columnar article further includes a plurality of photovoltaic cells.

16. The power generating apparatus of claim 1 wherein the base is attached to a movable vehicle.

17. The power generating apparatus of claim 1 wherein the base is attached to a building.

18. The power generating apparatus of claim 1 wherein the columnar article is a tree.

19. The power generating apparatus of claim 1 wherein the columnar article is an antenna tower.

20. The power generating apparatus of claim 1 wherein the columnar article is a flag pole.

21. The power generating apparatus of claim 3 wherein the signage comprises displays selected from the group consisting of: flags, banners, flat sign panels, balloons, parafoils, kites, and pennants.

22. The power generating apparatus of claim 3 wherein signage comprises recycled refuse selected from the group consisting of: soda bottles, milk jugs, clothing, palm fronds, bamboo, scrap metal, and thatch.
